(19) United States
(12) Patent Application Publication
(10) Pub. No.: US 2012/0274546 A1
(43) Pub. Date: Nov. 1, 2012

(54) Data input glove with instantaneous chord detection

(76) Inventor: Dilip Dalton, San Jose, CA (US)

(21) Appl. No.: 13/098,411

(22) Filed: Apr. 30, 2011

(51) Int. Cl. G09G 5/00

(52) U.S. Cl. 345/156

(57) ABSTRACT

The invention describes a data glove input device that relies on a novel chording mechanism. The device is comprised of one or two gloves with conductive elements covering the finger tips and additional conductive elements on the palm and the thumb. The conductive elements are divided into two groups of opposite polarity. A chord is formed by when two or more conductive elements of the same polarity are held in contact with each other. The device generates an output when a conductive element or a chord of one polarity makes or breaks contact with a conductive element or chord of the opposite polarity. The innovation lies with the large number of key combinations supported using this chording mechanism in an easily accessible manner.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

This application relates to data input devices, specifically to key based input using conductive contacts mounted on a glove.

2. Prior Art

There are computer applications such as real-time games where a keyboard is used simultaneously with a mouse or a joystick. When using such applications the user is sometimes forced to also use a keyboard for certain input like hotkey commands. At such times the user's focus and concentration is interrupted to look at the keyboard to find the desired key, press the key, and then turn attention back to the application. A large number of such interruptions cause the user to lose efficiency.

One solution is to use a dedicated keypad under one hand while the other hand operates the mouse. There are a couple of disadvantages. Firstly, the hand has to always rest on the keypad to allow quick pressing of the desired key. Secondly, the keypad has a limited number of keys and when the user has to use the keyboard, the interruption is bigger as the user first has to turn attention to the keyboard to find the desired key, press the key, turn attention to place the hand on the keypad and then turn attention back to the application.

Glove based key input devices remove the problem of having to always keep the hand on a keypad, since the keys are now mounted on the hand. They are thus less intrusive when used with a device such as a mouse or a joystick. Some of them work by having specialized sensors to identify if a finger is bent or if a certain pressure is applied by the finger on a sensor. These devices tend to be expensive to manufacture because of the specialized sensors. A simple and cost effective way to identify a signal is when two electrical contacts of opposite polarity come in contact with each other. U.S. Pat. No. 6,885,316 discloses a glove based key input device where electrical contacts are mounted on the thumb and the fingers. Each thumb contact represents a row of the keyboard and each finger contact represents a key of a particular keyboard row, depending upon which thumb contact it comes in contact with. The drawback is that a large number of contacts are needed to emulate a large number of keys.

The number of contacts needed for emulating a certain number of keyboard keys can be reduced by using a chording mechanism. Chording is a mechanism by which a user simultaneously operates a combination of contacts/sensors to generate a signal. Chording gives us a large number of combinations from a small number of contacts. U.S. Pat. No. 6,141,643 describes a chorded data input device using a single glove. All five fingers are used to form a chord and support a total of 30 (2̂5-2) combinations. It has the drawback of not supporting simultaneous key presses, because the state of all five fingers is needed to represent a particular chord.

The paper “A Pair of Braille-Based Chord Gloves”—Proceedings of the 6th International Symposium on Wearable Computers (ISWC'02), gives details of a Braille input device. This device is based on a mechanism similar to those employed by chording keyboards.

All existing chording gloves use a chording method similar to those employed by chording keyboards. This chording method relies on a threshold time to recognize a chording action. Using a threshold time has the following drawbacks:
1. The speed of the input device is limited by the threshold time. For example, if the time is 500 ms to recognize a chording action, then the user cannot enter data faster than 120 characters per minute.
2. The device will spend the full amount of the threshold time to recognize a chording action, so it does not help if the user was faster in making the chord. The user needs to hold the chord for the full duration of the threshold time.
3. The user's concentration is fully taken by the need to enter a chording action quickly and correctly. This aspect makes the device not well suited for applications where the user has to switch between multiple input devices.
4. In order to correctly enter a chord within the threshold time, the user needs to learn all the chording patterns well. It takes time and practice to do this.

All existing glove based chording devices use some form of threshold time to identify a chording action. As shown in the drawbacks of using a threshold time, there is scope for improvement in the chording action method.

### SUMMARY

In accordance with one embodiment, the input device consists of a single glove. There is a conductive element on each finger tip and thumb. There are additional conductive elements on the proximal portion of the thumb, metacarpal portion of the thumb and the palm. The conductive elements are controlled by a microprocessor that is also housed on the glove. The four conductive elements on the finger tips are charged with a certain polarity, and the remaining conductive elements are charged with an opposite polarity. Any combination of the four elements on the finger tips can be held in contact with each other to form a chord of the same polarity. When the chord comes in contact with an element of opposite polarity, a closed circuit is detected and data is sent to the computer. It will be described how this embodiment can be used to supplement the keyboard.

In accordance with another embodiment, the input device consists of two gloves with conductive elements on the finger tips of each glove. This embodiment supports a large number of keys. The conductive elements are connected to a microprocessor that is housed on one of the gloves. One glove has its elements positively charged and the other glove has its elements negatively charged. It will be described how this embodiment is used to replace a keyboard. It will also be described how this embodiment is used as Braille input device.

### DRAWINGS

### Figures

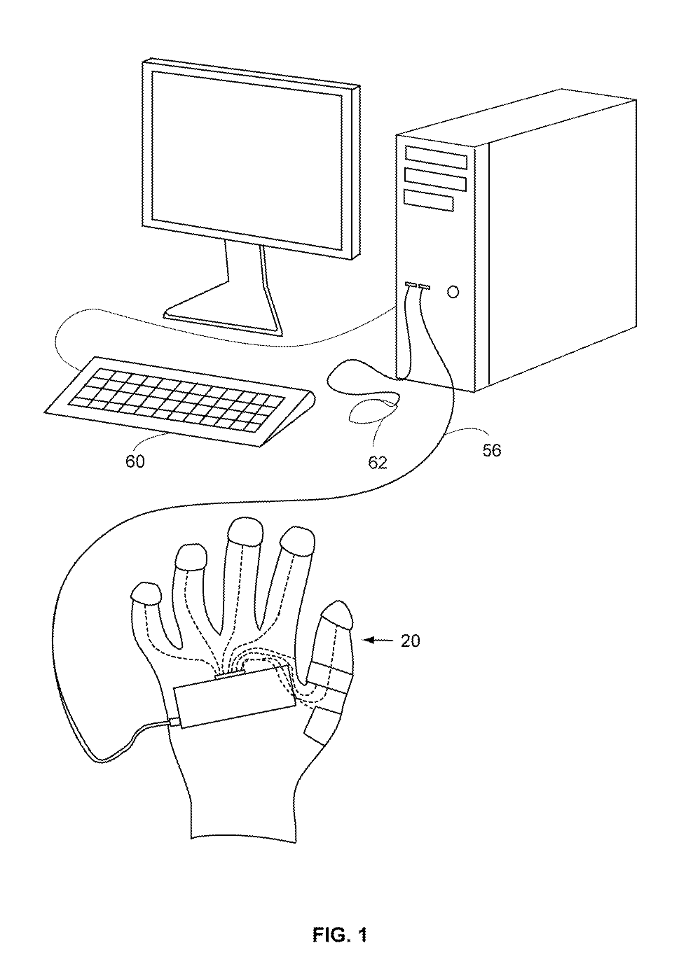

FIG. 1 is a perspective view of the first embodiment.

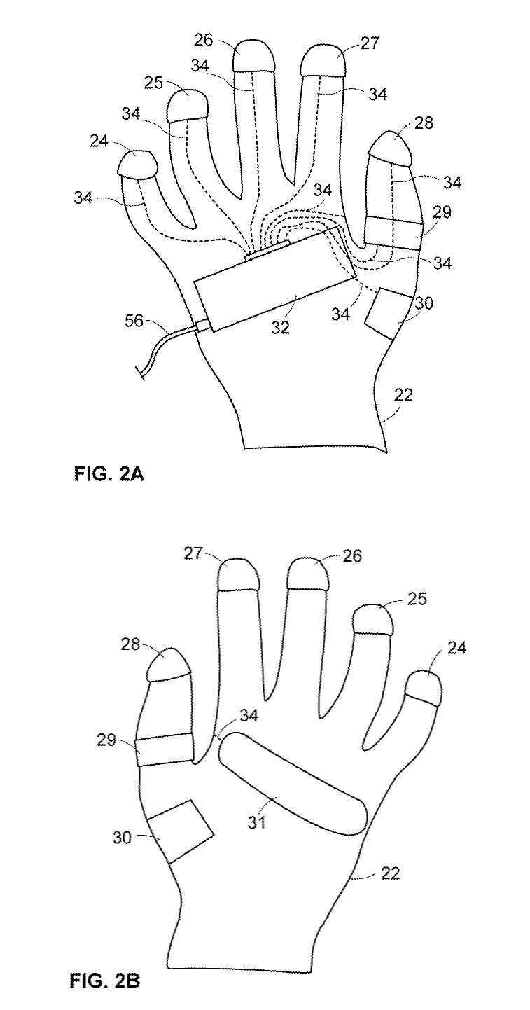

FIG. 2A is a dorsal view of the device worn on the left hand according to the first embodiment.

FIG. 2B is a palmar view of the device shown in 2A.

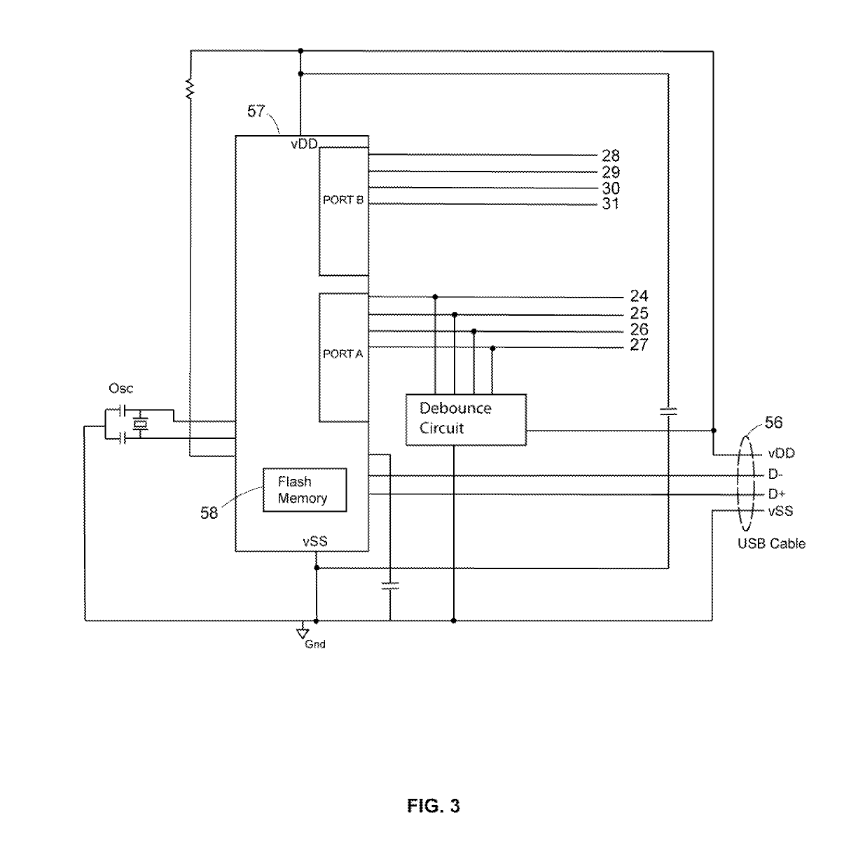

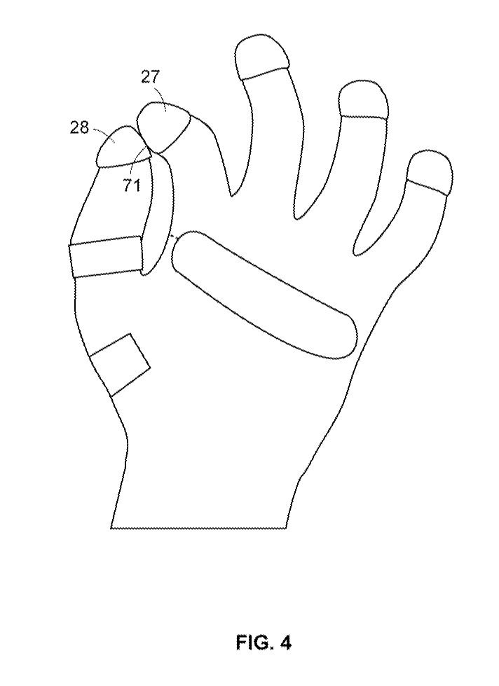

FIG. 3 is the processor circuit diagram for the first embodiment.

FIG. 4 shows two conductive elements of opposite polarity making an electrical contact.

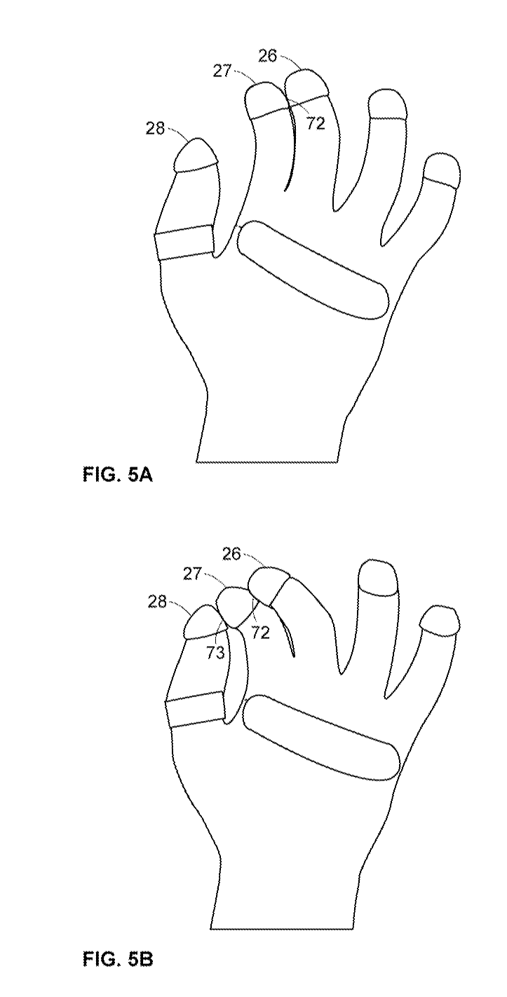

FIG. 5A shows the formation of a chord element

FIG. 5B shows the chord element in 5A making an electrical contact with a conductive element of opposite polarity.

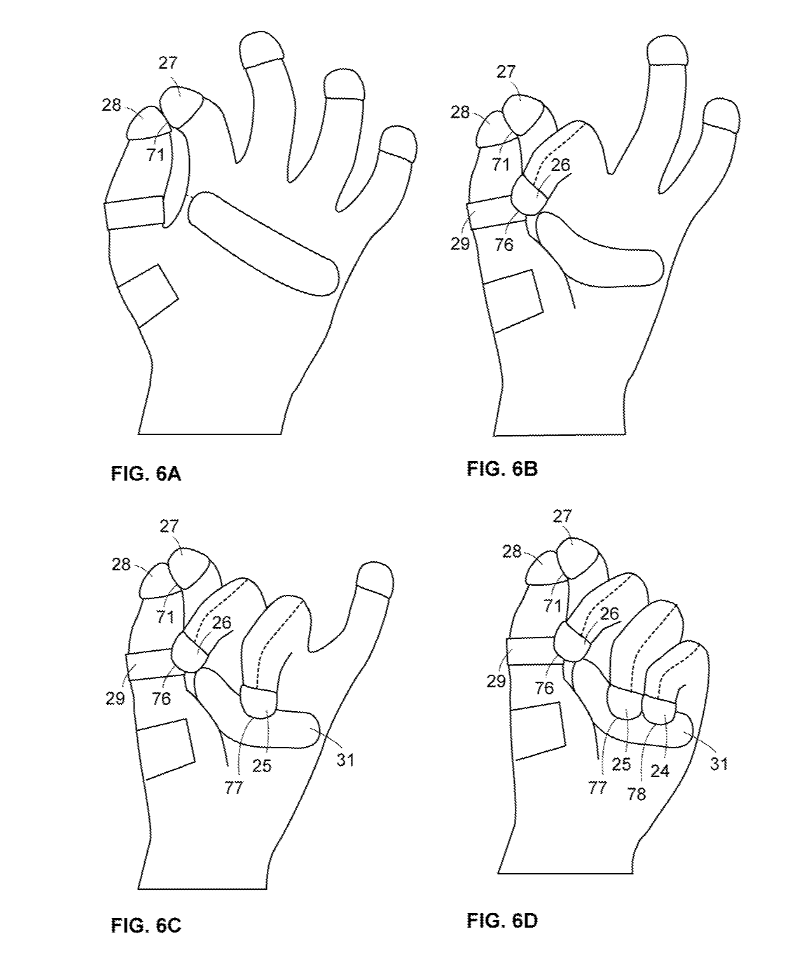

FIG. 6A-6D depicts the formation of four simultaneous single keys

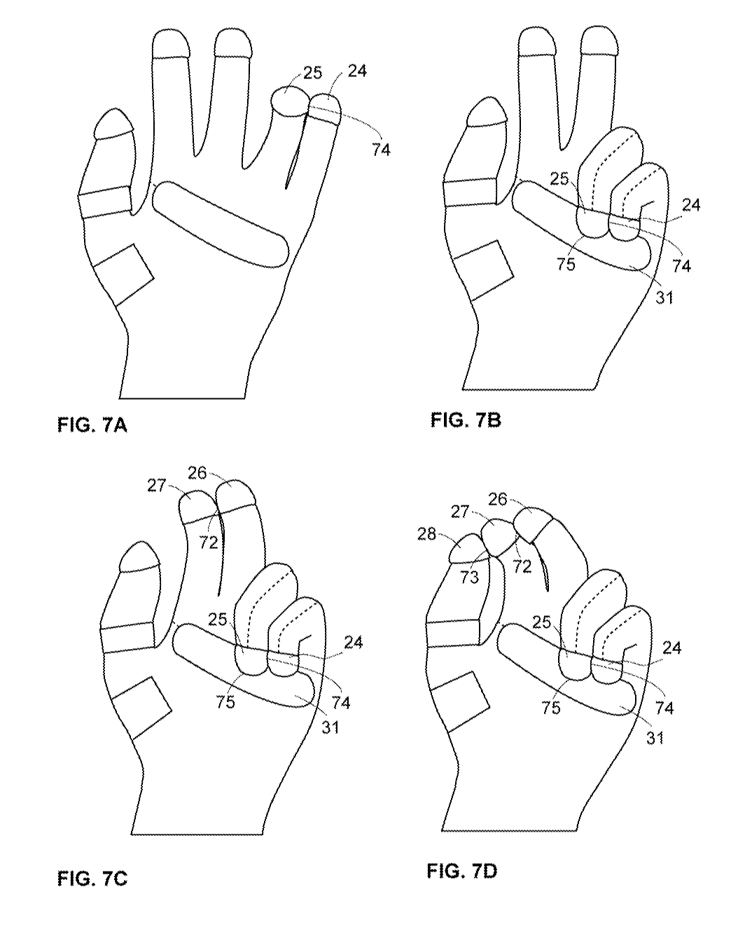

FIG. 7A-7D depicts the formation of two simultaneous chording keys

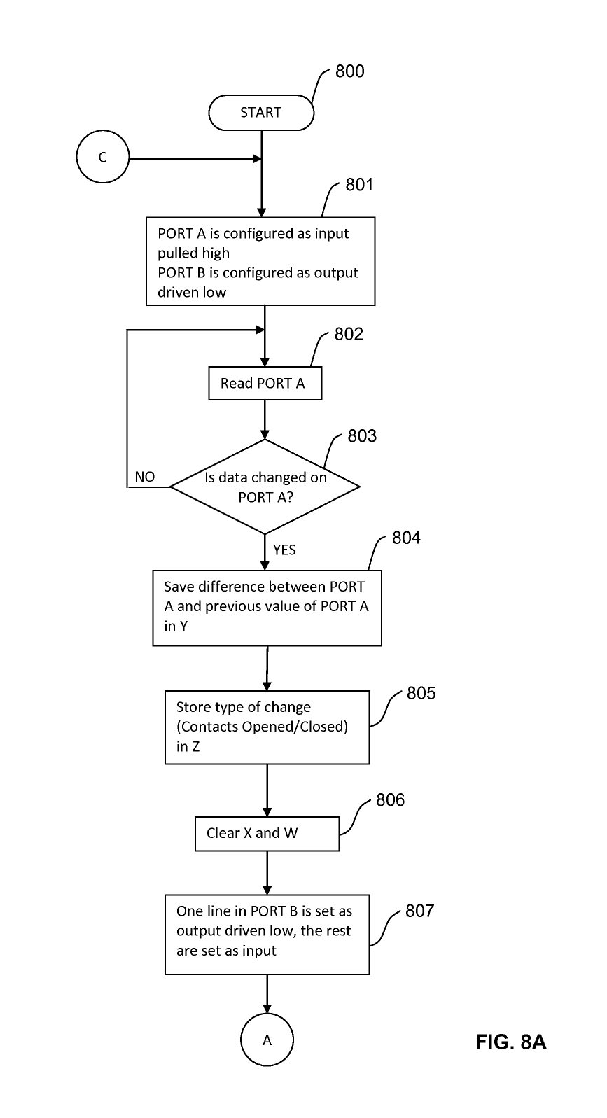

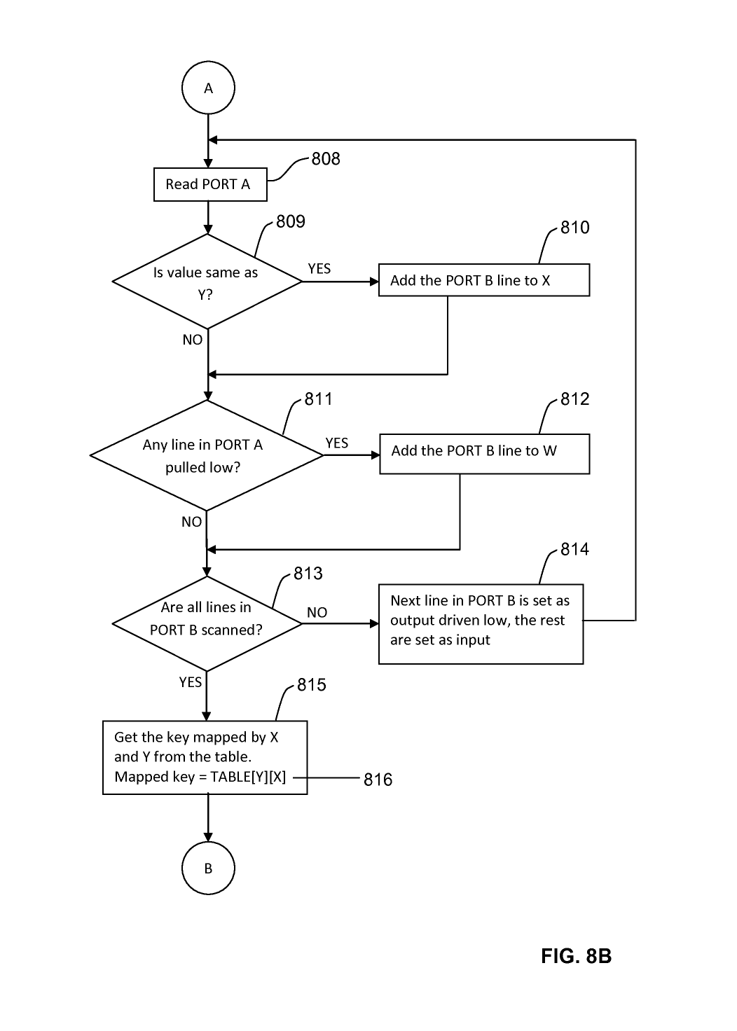

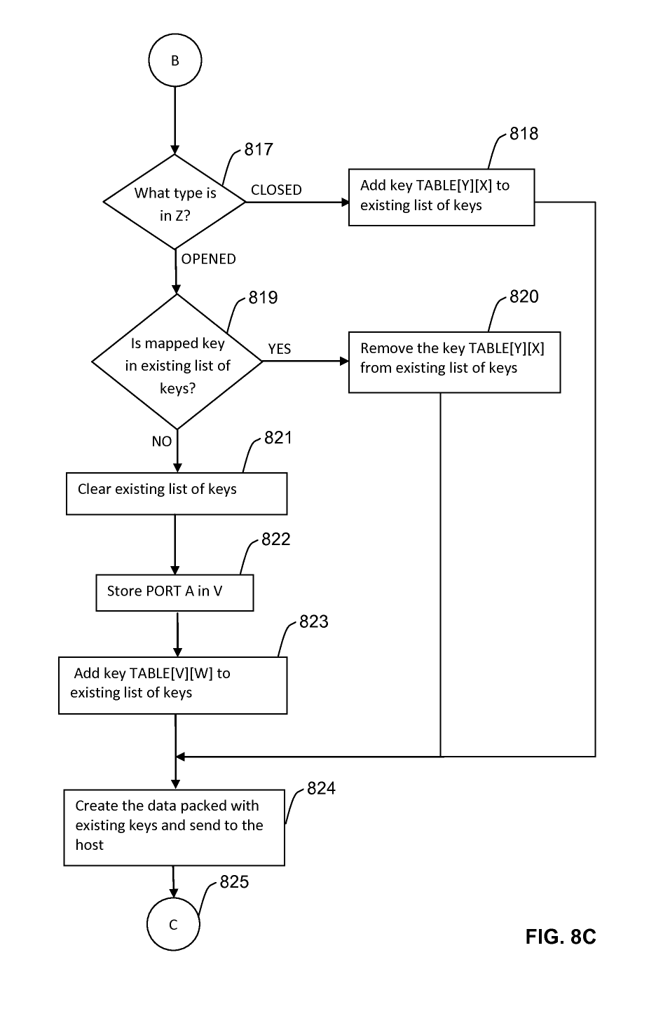

FIG. 8 shows a flow chart of the algorithm involved in identifying a chording action.

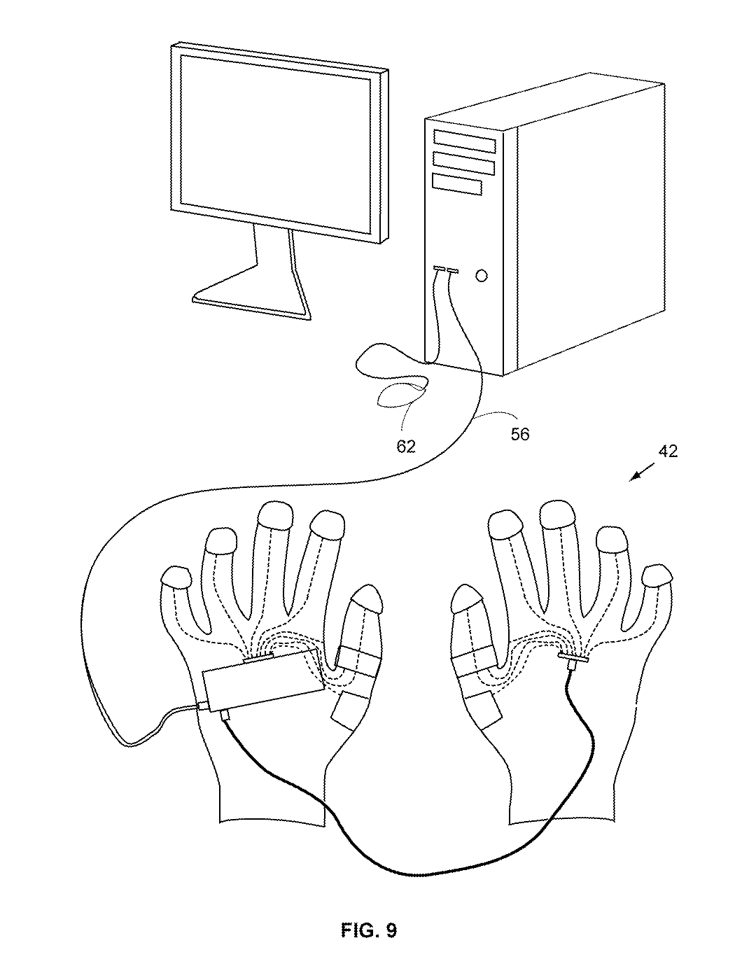

FIG. 9 is a perspective view of the second embodiment.

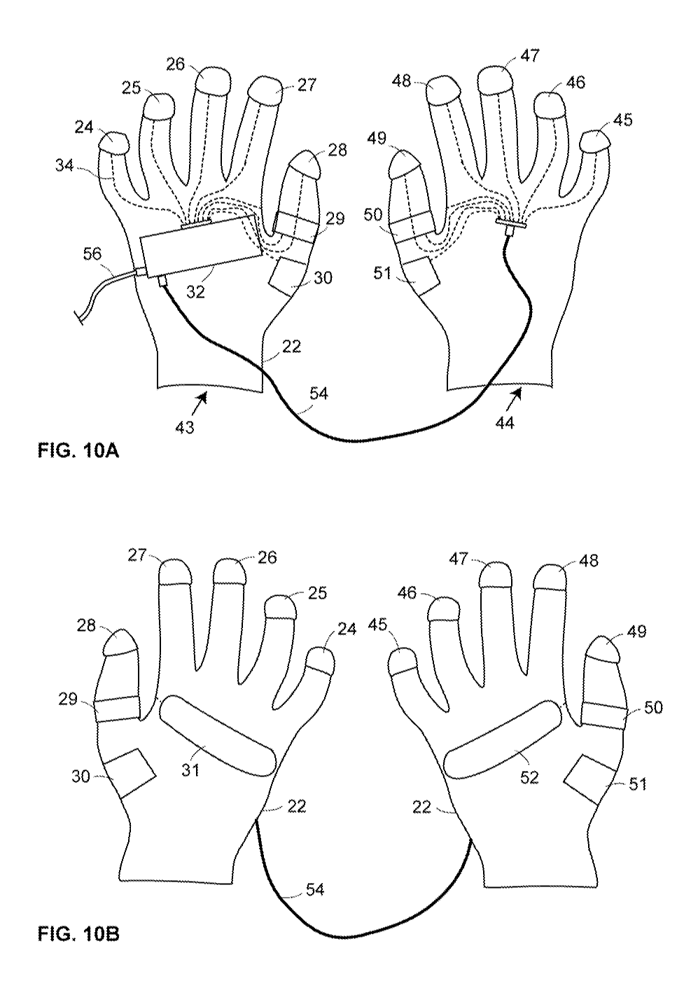

FIG. 10A is a dorsal view of the second embodiment.

FIG. 10B is a palmar view of the second embodiment.

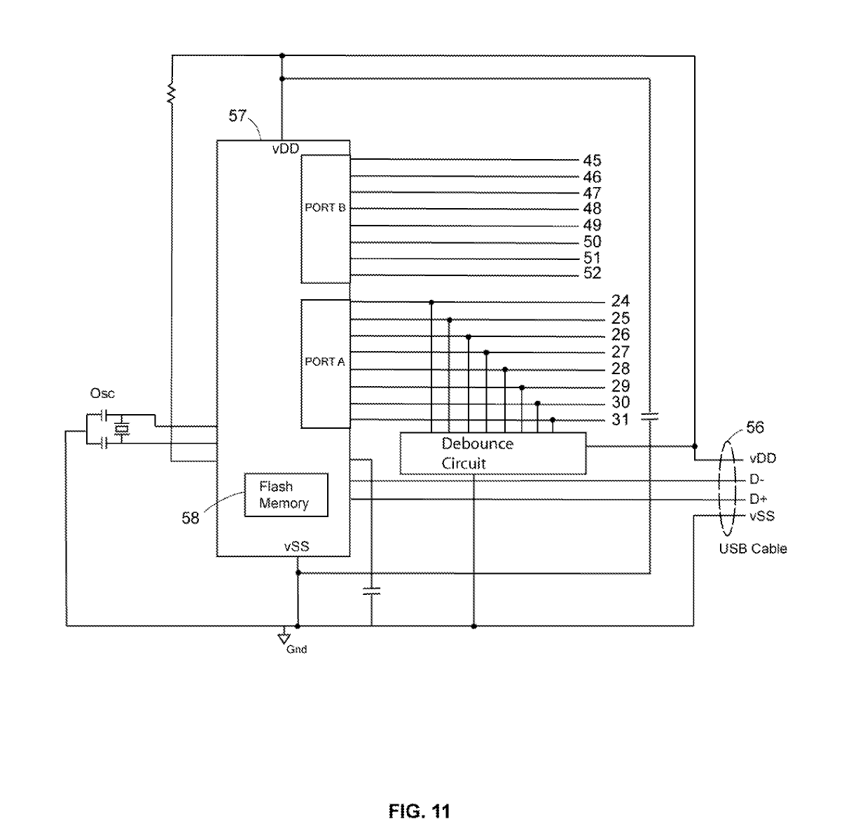

FIG. 11 is a block diagram of the microprocessor circuit and its connections with the conductive elements on two gloves and the port on the computer for the second embodiment.

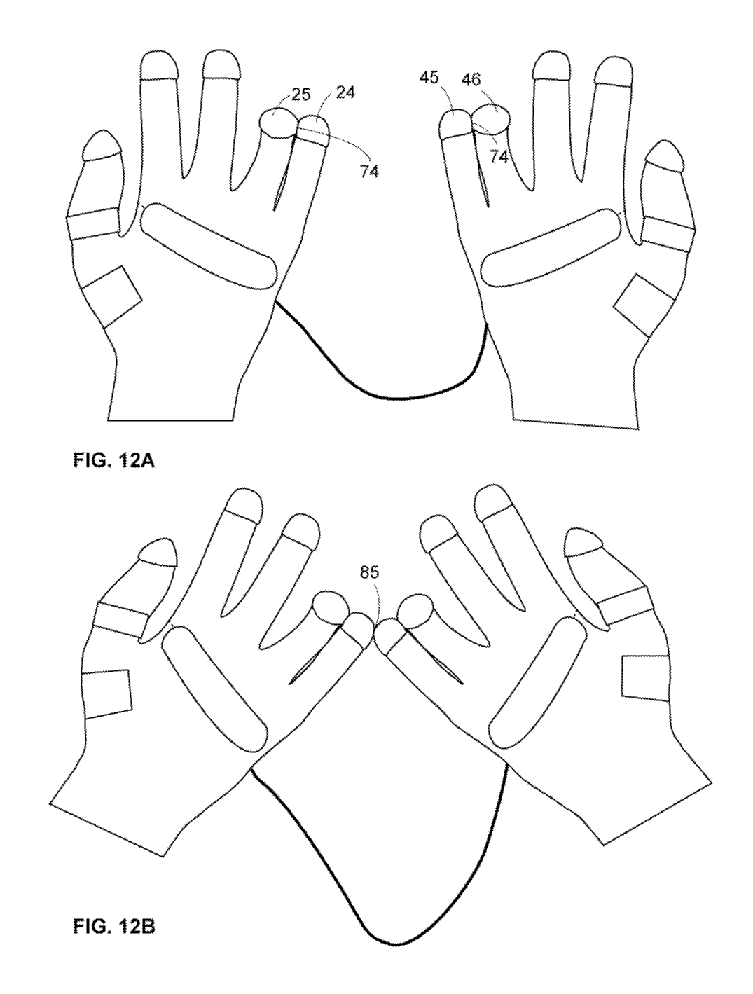

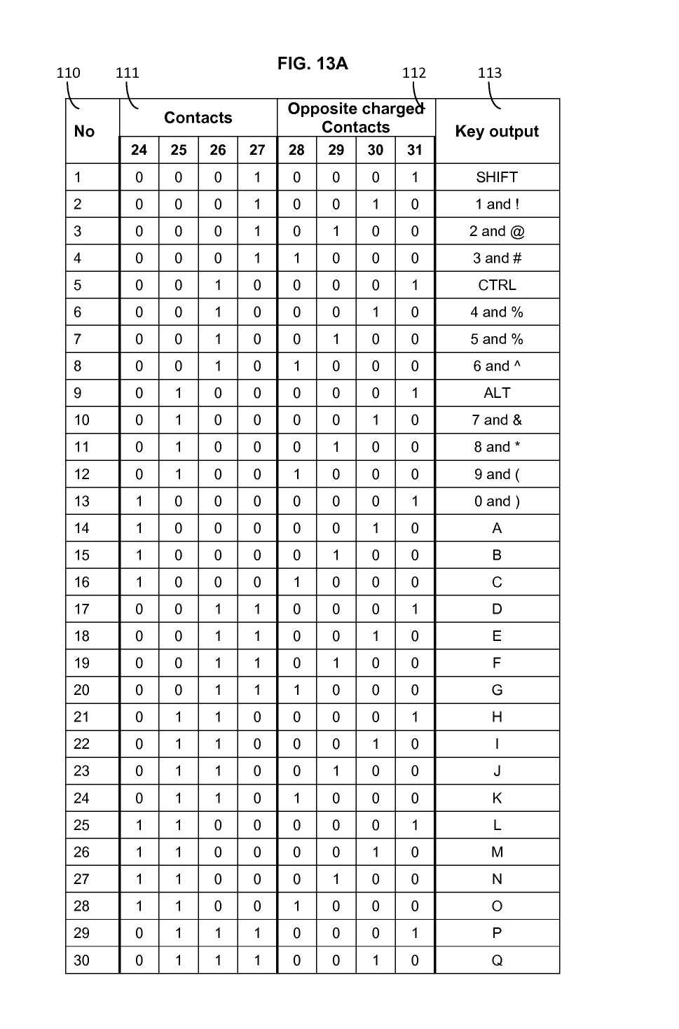

FIG. 12A shows the formation of the chords for the second embodiment.

FIG. 12B shows two chords of opposite polarity making an electrical contact.

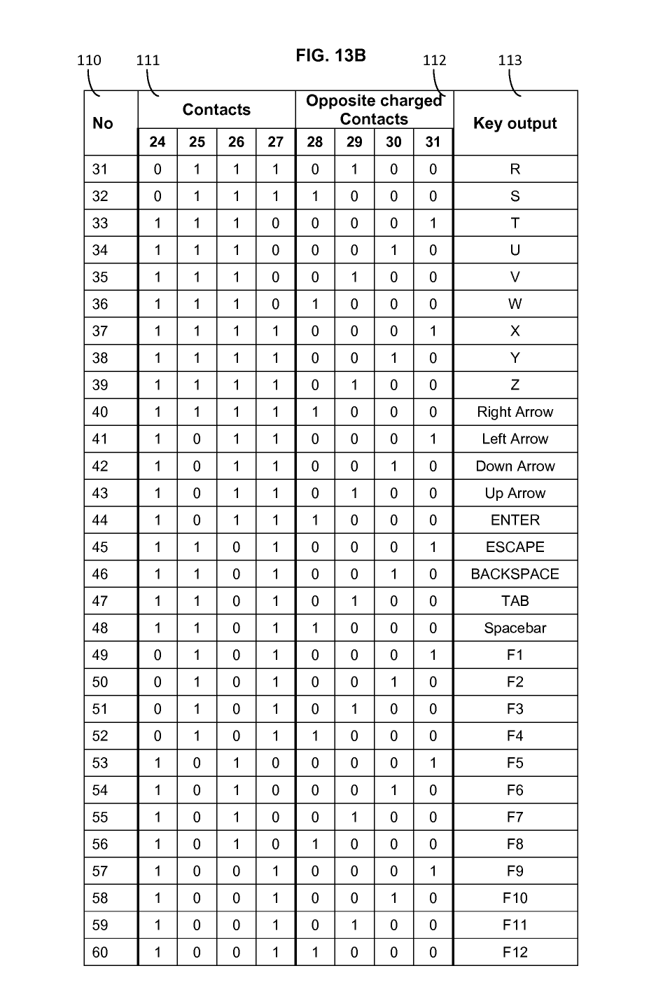

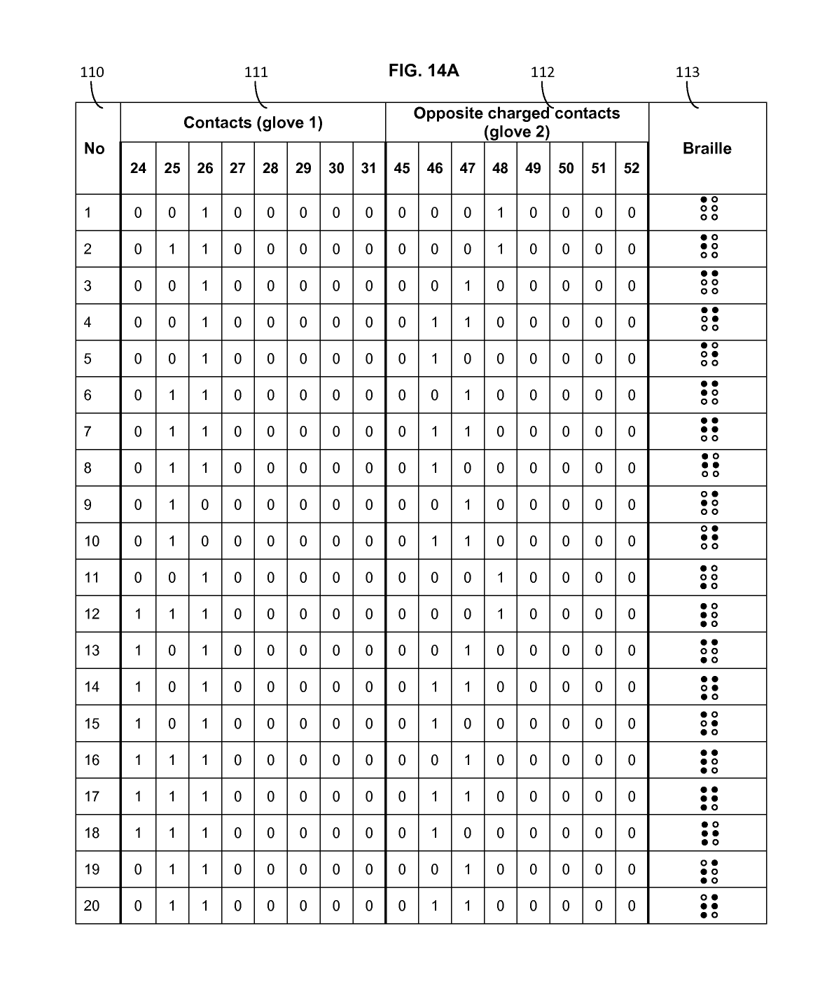

FIG. 13 is an example of a mapping table between chord combinations and keyboard keys for the first embodiment.

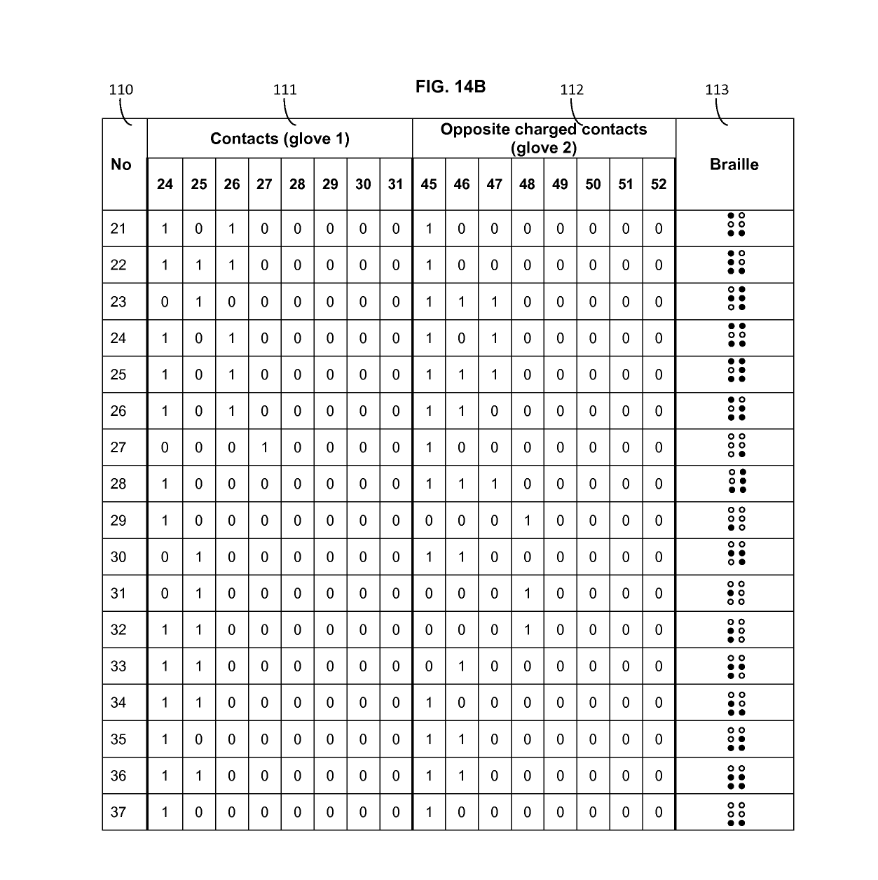

FIG. 14 is an example of a mapping table between chord combinations and Braille data for the second embodiment.

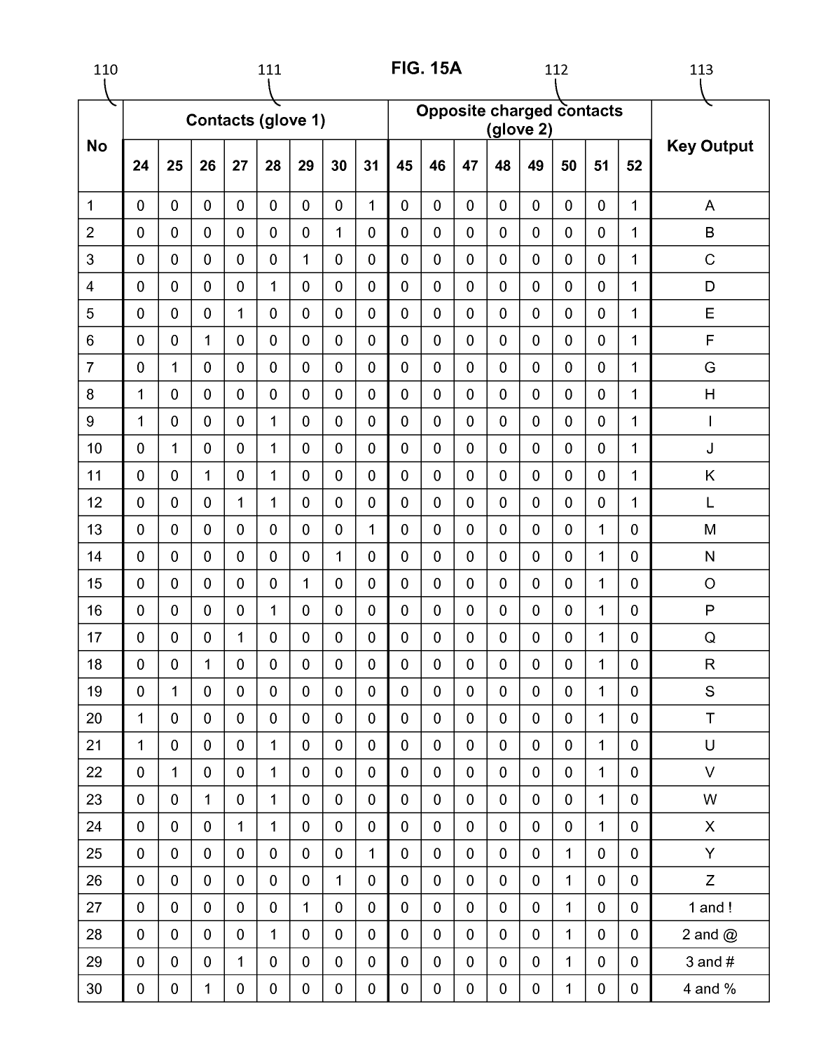

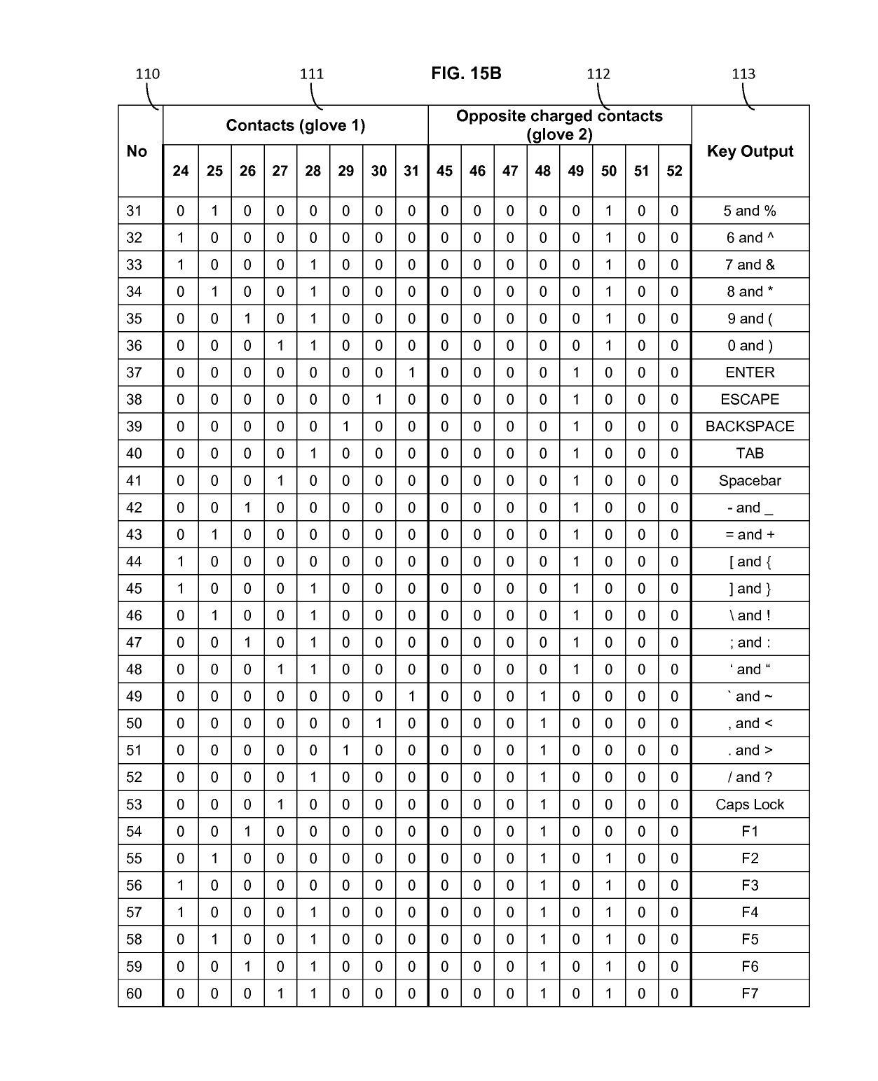

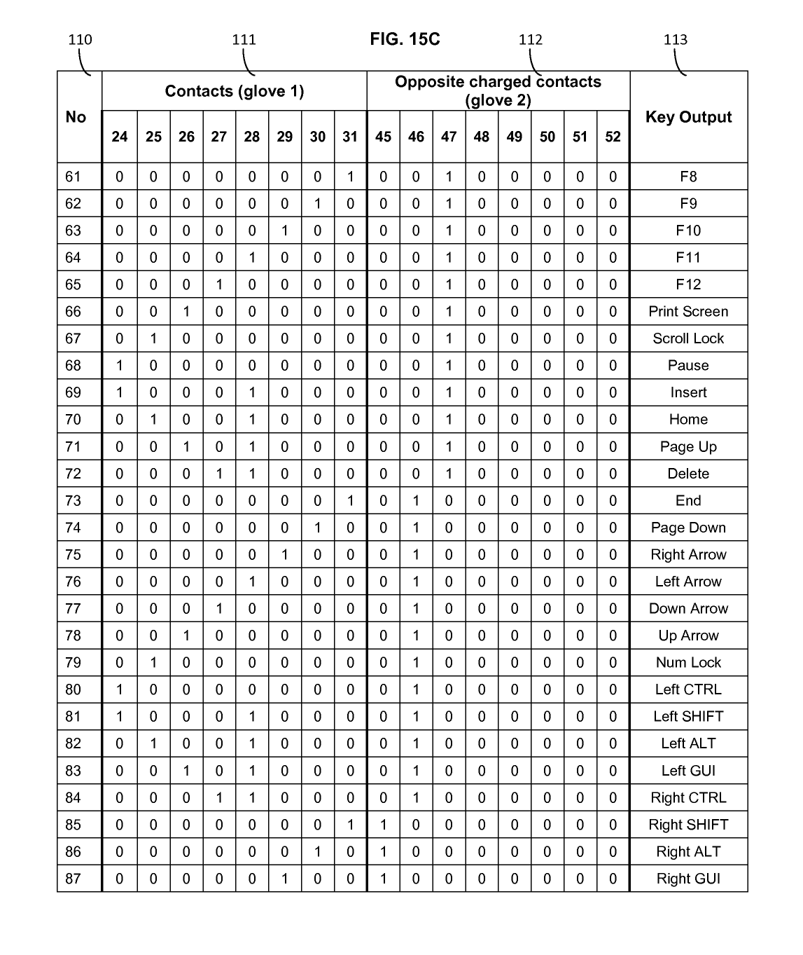

FIG. 15 is an example of a mapping table between chord combinations and keyboard keys for the second embodiment.

### Reference Numerals

20: overall input device for the first embodiment
22: Glove body
24: Thimble shaped conductive element on the pinky finger
25: Thimble shaped conductive element on the ring finger
26: Thimble shaped conductive element on the middle finger
27: Thimble shaped conductive element on the index finger
28: Thimble shaped conductive element on the thumb
29: Conductive element around the proximal portion of the thumb
30: Conductive element on the metacarpal portion of the thumb
31: Conductive element on the palm
32: Processor circuit
34: wire connecting a conductive element to the processor 32
42: overall input device for the second embodiment
43: Glove containing the processor for the second embodiment
44: Second glove in the second embodiment
45: Thimble shaped conductive element on the pinky finger of glove 44
46: Thimble shaped conductive element on the ring finger of glove 44
47: Thimble shaped conductive element on the middle finger of glove 44
48: Thimble shaped conductive element on the index finger of glove 44
49: Thimble shaped conductive element on the thumb of glove 44
50: Conductive element around the proximal portion of the thumb of glove 44
51: Conductive element on the metacarpal portion of the thumb of glove 44
52: Conductive element on the palm of glove 44
54: cable connecting wires from the second glove 44 to the processor 32 on the first glove 42
56: USB cable connecting the processor 32 to a host device
57: Microprocessor
58: Flash memory
60: keyboard
62: computer mouse

### DETAILED DESCRIPTION

### First Embodiment—FIGS. 1-8, 13

### Construction

In FIG. 1, the first embodiment of the present invention is illustrated in its intended mode of use, as a data input device 20 to supplement the keyboard 60 when working with a computer mouse 62. The device 20 as depicted is constructed on a left hand glove, so the user operates this device 20 with the left hand and the mouse 62 with the right hand. The device can similarly be constructed on a right hand glove, it being a mirror image of the device 20.

FIG. 2 shows the dorsal and palmar views of the device. The input device 20 includes a glove assembly 22 fitting the hand of the user. The glove assembly is made of fabric, similar to that used in glove liners. This allows the glove to stretch and fit different hand sizes. There are conductive elements 24-28 shaped like a thimble on the glove fingers, a conductive element 29 that wraps around the proximal portion of the thumb, a conductive element 30 on the metacarpal portion of the thumb and a conductive element 31 on the palm. An insulation layer is present between the conductive element and the glove material. The conductive elements are preferably made of copper that is gold plated. For low cost solutions a material which has good corrosion resistance and electrical conductivity, such as phosphor bronze can be used. The conductive elements 24-31 are connected to the glove using a strong adhesive or any other suitable method. The edges of the elements 24-31 are reinforced to the glove so that it does not bend and peel off. Insulated wire conductors 34-41 connect the elements 24-31 to the processor 32. The wires 34-41 can either be connected to the outside of the glove 22 or run between two layers of the glove 22. The ends of the wires are soldered directly to the conductive element on one end and the circuit board on the other. The wire can also be soldered to a connector and this allows the flexibility of changing components. The processor 32 is connected to the host device using a USB cable 56. The device can also be designed to wirelessly connect to the computer and in this configuration; there is no need for the USB cable 56.

The conductive elements on the finger tips 24-28 are thimble shaped, and cover the top of the finger completely. This is an important aspect of the device as this shape helps to form the chording action with the finger tips. This thimble shape allows the conductive element on the finger 24-27 to make physical contact with any other conductive element 24-31 on the glove 22.

FIG. 3 shows the block diagram of the processor and its connections. The conductive elements 24-31 are connected using wires 34-41 through a de-bounce circuit to the I/O ports of a microprocessor 57. The de-bouncing circuit helps to produce a clean signal transition when a contact between two conductive elements is made or broken. The microprocessor has an internal memory 58 to store the mapping table. This mapping table is used to determine which data is sent corresponding to the signal generated. The mapping table can be configured by software. The data generated by the device is sent through the USB cable 56 to the host machine. The conductive elements 24-27 are connected to PORT A and are pulled up high. The conductive elements 28-31 are connected to PORT B and pulled down low.

The device gets its power from the USB cable 56 connected to the host machine. The device can also be configured to operate in a wireless configuration, with the device being powered through a battery.

### Operation

A conductive element can either be in the open or closed state. The state is open if a conductive element is not in contact with another conductive element of opposite polarity. The state is closed if a conductive element is in physical contact with a conductive element of opposite polarity. When any conductive element 24-27 that is pulled high comes in physical contact or breaks physical contact with a conductive element that is pulled low 28-31, a signal is triggered. This signal can be identified because the voltage levels change from high to low or vice versa on the lines connected to the pull-up resistors. When this signal is identified the processor finds the data corresponding to the state of conductive elements 24-31 from a mapping table and sends it to the host device.

FIG. 4 discloses how a signal is generated based on a single key contact. A single key contact occurs when a single conductive element makes contact with an element of opposite polarity. One conductive element is weakly pulled high by the pull-up resistor and the other conductive element is held low. When the single key contact is made, the signal changes from high to low on the conductive element connected to the weak pull-up resistor. Similarly, when a contact is broken, the signal is changed from low to high on the conductive element because of the pull-up resistor. This signal change causes the processor to find the data corresponding to the two conductive elements. The data is then packaged in a USB packet and sent to the host device.

FIG. 5 discloses how a signal is generated based on a chording contact. A chording contact is comprised of two steps. The first step involves the formation of the chord. FIG. 5A depicts this step. The elements 26-27 make a chording contact 72. In a chording contact, no signal change occurs because all the conductive elements involved in a chord are of the same polarity. FIG. 6B depicts the second step. The chord 26-27 comes in contact 73 with a conductive element 28 of opposite polarity and a signal change instantaneously occurs on all the conductive elements of the chord. The instantaneous aspect of this chording method is made possible as all the elements of the chord 26-27 are in contact 71 with each other. Though one element 27 of the chord makes contact with the opposite charged element 28, all the elements 26-27 of the chord experience a signal change from high to low, because the conductive elements 26-27 are in contact with each other. A similar behavior occurs when a contact is broken. As soon as the chord breaks contact 73 as depicted in FIG. 6A, all the elements of the chord all pulled up high instantaneously by the pull up resistors.

FIG. 6 discloses how this embodiment supports simultaneous single key presses. A maximum of 4 simultaneous keys can be supported by this embodiment and this is represented by the key generating contacts 71, 76, 77 and 78.

FIG. 7 discloses how this embodiment supports simultaneous chording key presses. Two simultaneous chording key presses are represented by the key generating contacts 73 and 75.

FIG. 13 discloses a table for mapping the state of the conductive elements to the data output by the device. The table consists of three main columns 111-113. The first two columns 111,112 represent the state of the conductive elements in binary numbers and the third column 113 represents the data output. Column 111 represents the state of the conductive elements on the four fingers and column 112 represents the state of the opposite charged conductive elements. The binary number entry in columns 111,112 has a ‘1’ for all the conductive elements that are in the closed state and a ‘0’ for all conductive elements that are in the open state. If the binary number has more than one bit with the value ‘1’, then that represents a chording contact. Column 111 represents the state of the conductive elements 24-27 and column 112 represents the state of the conductive elements 28-31. The mapping table is stored in non-volatile memory as a two-dimensional array. The first subscript of the array represents the binary number in one column 111 and the second subscript of the array represents the binary number in the other column 112.

FIG. 8 discloses how the processor generates the data based on a signal change.

The process starts at the terminal 800. The process continuously runs in a loop to see if any voltage levels have changed on the lines 24-27. At the beginning of the loop the status of the ports connected to the conductive elements are initialized 801. PORT A is configured as input and PORT B is configured as output that drives the conductive element 28-31 low. The process continuously reads 802 the value of PORT A to see if it has been changed 803. If the value has changed then the lines whose signals have changed are stored by setting the corresponding bits to ‘1’ in memory location Y 804. Memory location Z 805 is used to record the type of change made. If the change is due to contact made between the fingers then the type is closed, else if a contact is broken, the type is open. Memory locations W and X are used during the scanning process to find the state of PORT B. Memory location W is used to store all the lines in PORT B that are currently connected with any lines in PORT A. This location W is valid for both closed and open actions. Memory location X is used to store the lines in PORT B that caused the change in memory location Y. This location X is only valid for the closed action. Each bit in W, X and Y represent the state of a conductive element expressed as a binary number. The locations W and X are cleared 806 before the start of the scanning process. At the start of the scan, a line in PORT B is set as output driven low, while the rest are set as inputs 807. The register PORT A is now read 808 to find if a change has been caused due to 807. If the changed lines are the same 809 as in location Y, then the bit corresponding to the output line in PORT B is set to ‘1’ in memory location X 810. Additionally, if any lines in PORT A are found 811 to be pulled low due to the output line in PORT B, then the bit corresponding to the output line is set to ‘1’ in memory location W 812. This scanning process repeats 813-814 until all the lines in PORT B are checked. After the states of PORT A and PORT B have been found, the next process is to find the data to send to the host device. Using the values of locations X and Y, the mapping table is looked up 815 to find the data entry.

The Location Z is checked 817 to find the type of action made by the user of the device. If the signal change is due to a closed action, then the data is added to an existing list of data 818. An existing list is necessary to support simultaneous key presses; for e.g., if the current data looked up in the mapping table is a DEL key press and the existing data contains CTRL-ALT, then the data sent to the host is CTRL-ALT-DEL.

If the type of action is open 817, the mapped data needs to be removed from the existing list of data. If the mapped data is found 819 in the existing list of data, it is removed 820. If the mapped data is not found in the existing list of data, then the existing list is cleared 821. The existing state of PORT A is stored in memory location V 822. If there is data mapped by locations V and W, it is added to the existing list 823.

A data packet is created using the existing data list and send to the host device 824. The value of PORT A is saved so it can be used in the next comparison 803. This whole process again continues from the beginning 825.

The TABLE 816 array is a two dimensional array that stores the mapping data. The first index represents the state of all the conductive elements 24-27 of the same polarity and the second index represents the state of all the conductive elements 28-31 of opposite polarity. The size of this array is 2⁴×2⁴=256 entries.

Two examples are described below. The first is for a single key touch and the second for a chording touch. In these examples, TABLE 816 represents the mapping table of FIG. 13, the lines 24-27 represent a four bit number with line 24 being the most significant bit and the lines 28-31 represent a four bit number with the line 28 being the most significant bit. An example of a single key contact is shown in FIG. 4, the entry number 110 in FIG. 13 associated with this contact is 4, the value of memory location Y that represents the state of the lines 24-27 is 1 and the value of memory location X that represents the state of the lines 28-31 is 8. The data value associated with this value of Y and X is 3, and this is the value stored in the array location TABLE[1][8]. An example of a chording contact is shown in FIG. 5, the entry number 110 in FIG. 13 associated with this contact is 20, the value of Y is 3 since it represents the chord of the lines 26,27 and the value of X is 8, and this is the value stored in the array location TABLE[3][8]. The data value associated with this contact is “G”.

### Second Embodiment—FIGS. 9-12

### Construction

FIG. 9 shows a second embodiment of the device. FIG. 10 shows the dorsal and palmar views of this embodiment. This embodiment comprises of two gloves 43, 44. The main glove 43 construction is same as the one described in the first embodiment. The processor box has an additional socket to connect with the second glove 44. The second glove 44 does not have a processor box. The wires from the conductive elements 45-52 on the second glove 44 connect to the processor 32 on the first glove 43 through a cable 54.

FIG. 11 shows the circuit diagram of the second embodiment. The second embodiment has double the number of conductive elements compared to the first embodiment. The second difference is that all the conductive elements on a glove are of the same polarity, and each glove is held at opposite polarity as shown in the circuit diagram. The conductive elements 24-31 are weakly pulled high by the pull-up resistors, and the conductive elements 45-52 are held low.

### Operation

The operation of the device as described in the flow chart FIG. 8 for the first embodiment is the same for the second embodiment. The difference lies in the size of the TABLE array that stores the mapping data, given that the number of conductive elements has doubled from eight to sixteen compared to the first embodiment. Glove 43 has eight conductive elements 24-31, and the state of which is represented using a byte. Similarly, glove 44 has eight conductive elements 45-52 of opposite polarity whose state is represented using another byte. The size of the TABLE array holding all the combinations is 2⁸×2⁸=65536 entries. The table does not have to be this large and can be configured based on a subset of the chord combinations.

FIG. 12 depicts the usage of this device. A chording contact is first made in FIG. 12A. A signal change is then initiated by bringing the conductive elements of one glove in contact with the conductive elements of another glove as shown in FIG. 12B. In this embodiment, the chording action can be performed on both gloves. This allows the device to support a large number of combinations and hence data.

FIG. 14 and FIG. 15 show two configurations of this embodiment based on the type of data mapping. FIG. 14 configures this device as a Braille input device and FIG. 15 configures this device as a keyboard input device.

Braille is a type of data input that naturally map to a chorded form of data entry. FIG. 12 discloses how this embodiment can be used as a Braille input device. Braille represents its characters using two vertical lines, with a maximum of three dots on each line. With a conductive element on a finger mapped to a Braille dot, Braille characters naturally map to chording actions. A mapping table between the conductive elements and Braille characters is shown in FIG. 14.

An example of a Braille contact is described. TABLE 816 here represents the mapping table of FIG. 14, the lines 24-31 represent a byte with line 24 being the most significant bit and the lines 45-52 represent another byte with the line 45 being the most significant bit. In the example shown in FIG. 12, the entry number 110 in FIG. 14 associated with this contact is 37, the value of memory location Y that represents the state of the lines 24-31 is 192 and the value of memory location X that represents the state of the lines 45-52 is 192. The Braille character associated with this value of Y and X is [symbol] , and this is the value stored in the array location TABLE[192][192].

FIG. 15 depicts the mapping table for a standard 104 keyboard. Using this mapping table this embodiment can be used as a full replacement of a keyboard. This mapping table is configurable using software and is stored on the device itself. So no special drivers are needed to use this device. This device will function as a normal keyboard when plugged into a host machine.

### Advantages

1. The chording method described is non-intrusive due to the following reasons:
   a. The formation of the chord is independent of generating the signal.
   b. Not all the elements of the chord have to be in physical contact with the element of opposite charge.
2. Supports simultaneous key actions. No alternatives arrangements such as a mode key are necessary.
3. The chording method reduces user error by allowing a chord to produce a signal with a single contact. In prior chording methods, the user has to make all the conductive elements form a chord and trigger a signal simultaneously, this is error prone compared to making a single contact with a chord.
4. A large number of chord combinations are supported. The second embodiment can theoretically support (2̂8)*(2̂8)=65536 chord combinations. If the elements on the thumb and palm are excluded, the second embodiment can support (2̂5)*(2̂5)=1024 chord combinations. This is more than what the current chording glove input devices support.
5. The chord detection is instantaneous since the chord is already formed when the contact is made with an element of opposite charge. No threshold time is needed as in previous chording mechanisms to allow the user to form the desired chord.

I claim:

1. A data input device comprising:
One or two gloves,
A microprocessor attached to one of the gloves,
A plurality of charged conductive elements each connected to an I/O pin of the said microprocessor.
A subset of the said conductive elements is positively charged and the remaining subset of the said conductive elements is negatively charged.
A chord is formed when two or more conductive elements of the same polarity touch one another.
A signal is generated when said chord or a single conductive element comes in contact or breaks contact with another single conductive element or chord of opposite polarity. The microprocessor processes this signal and generates a corresponding output from a data table.

2. The data input device of claim 1, wherein the conductive elements on the fingertips are shaped in the form of a thimble.

3. A method for entering data using a chording mechanism, comprising the steps of:
Using an apparatus having one or two gloves, the apparatus having a microprocessor attached to one of the gloves, a plurality of charged conductive elements each connected to an I/O pin of the said microprocessor and mounted on the fingers, thumb and palm regions of the glove, the said conductive elements on the fingertips shaped in the form of a thimble, a subset of the said conductive elements positively charged and the remaining subset of the said conductive elements negatively charged.
Moving two or more conductive elements of the same charge to touch one another and create a chord; and
Moving said chord or a single conductive element to make or break electrical contact with another single conductive element or chord of opposite polarity; and generating a signal that is processed by said microprocessor to generate an output.
